(19) United States
(12) Patent Application Publication
(10) Pub. No.: US 2024/0210342 A1
(43) Pub. Date: Jun. 27, 2024

(54) RESISTIVE OXYGEN GAS SENSOR AND OXYGEN SENSOR DEVICE

(71) Applicants: Nagaoka University of Technology, Nagaoka-shi, Niigata (JP); KOA Corporation, Ina-shi, Nagano (JP)

(72) Inventors: Tomoichiro Okamoto, Nagaoka-shi, Niigata (JP); Kenichi Iguchi, Ina-shi, Nagano (JP); Yukiko Ota, Ina-shi, Nagano (JP); Ryosuke Komatsu, Ina-shi, Nagano (JP); Zoku Ko, Ina-shi, Nagano (JP); Tetsuro Tanaka, Ina-shi, Nagano (JP)

(21) Appl. No.: 18/579,171

(22) PCT Filed: Jun. 16, 2022
(86) PCT No.: PCT/JP2022/024193

§ 371 Date: Jan. 12, 2024

(30) Foreign Application Priority Data
Jun. 17, 2021 (JP) 2021-101083

(51) Int. Cl. G01N 27/12

(52) U.S. Cl. CPC G01N 27/125; G01N 27/123

(57) ABSTRACT

In a resistive oxygen gas sensor, an oxygen gas detection member for detecting oxygen gas contains, as a main component, a semiconductor material having a composition formula represented by RE(Ba₂₋ₓ, REₓ)Cu₃O, (wherein, RE is a rare earth element, x is 0≤x≤ 1.2, and y is 6.0≤y≤7.5).

### CROSS-REFERENCE TO RELATED APPLICATIONS

This application is the U.S. national stage of PCT/JP2012/024193 filed on Jun. 16, 2022, which claims priority of Japanese Patent Application No. JP 2021-101083 filed on Jun. 17, 2021, the contents of which are incorporated herein.

### TECHNICAL FIELD

The present disclosure relates to a resistive oxygen gas sensor and an oxygen sensor device.

### BACKGROUND

In the fields of scientific research, healthcare, industry, and so forth, it may be required to measure an oxygen gas concentration in an environment. As oxygen sensors for detecting the oxygen gas, oxygen sensors of a solid electrolyte type, a galvanic battery type, or the like are widely known. However, because these oxygen sensors have a complicated structure, it is difficult to reduce the size.

In contrast, JP3870261B proposes a resistive oxygen gas sensor in which a semiconductor material that undergoes a resistivity change when it comes into contact with oxygen gas in a state in which a predetermined voltage is applied is applied to a sensor portion for oxygen gas. It is thought that, compared to the oxygen sensor of the solid electrolyte type, the galvanic battery type, and so forth, such a resistive oxygen gas sensor can easily be reduced in size and cost, and practical applications are being advanced.

### SUMMARY

However, in the resistive oxygen gas sensor disclosed in JP3870261B, because the temperature dependency of the responsiveness (the detection sensitivity) is large, there remains room for improvement.

Accordingly, an object of the present disclosure is to reduce the temperature dependency of the responsiveness compared with a conventional resistive oxygen gas sensor.

As a result of extensive research on the operating temperature and the responsiveness of a resistive oxygen gas sensor, the inventors focused on a semiconductor material represented by a specific composition formula and completed the present disclosure based on this semiconductor material.

In other words, a gas sensor as an aspect of the present disclosure is a resistive oxygen gas sensor having an oxygen gas detection member that is made of ceramic and that detects oxygen gas, the oxygen gas detection member contains, as a main component, a semiconductor material having a composition formula represented by RE(Ba₂₋ₓ, REₓ)Cu₃O_{y} (wherein, RE is a rare earth element, a substitution amount x is 0≤x≤1.2, and a substitution amount y is 6.0≤y≤7.5).

According to the aspect of the present disclosure, compared with a conventional resistive oxygen gas sensor, it is possible to reduce the temperature dependency of the responsiveness.

### BRIEF DESCRIPTION OF DRAWINGS

FIG. 1 is a plan view for explaining a resistive oxygen gas sensor according to a first embodiment of the present disclosure.

FIG. 2 is a sectional view taken along line II-II shown in FIG. 1.

FIG. 3 is a plan view for explaining the resistive oxygen gas sensor according to a second embodiment of the present disclosure.

FIG. 4 is a sectional view taken along line IV-IV shown in FIG. 3.

FIG. 5 is a circuit diagram for explaining the resistive oxygen gas sensor according to the second embodiment.

FIG. 6 is a flow chart showing a production method of a semiconductor material that is applied to an oxygen gas detection member 13 of the first embodiment and the second embodiment.

FIG. 7 is a configuration diagram for explaining an oxygen sensor device.

FIG. 8 is a diagram showing a relationship between a temperature change and a resistance value change for test specimens 1 to 4.

FIG. 9 is a diagram showing a relationship between a temperature change and a resistivity change of the test specimens 1 to 4.

FIG. 10 is a diagram showing a temperature dependency of a factor m representing an oxygen partial pressure dependency.

FIG. 11 is a diagram showing an oxygen gas responsiveness of the test specimen 1.

FIG. 12 is a diagram showing an oxygen gas responsiveness of the test specimen 3.

### DETAILED DESCRIPTION OF PREFERRED EMBODIMENTS

A resistive oxygen gas sensor according to an embodiment of the present disclosure is an oxygen sensor capable of measuring oxygen gas in environment and specific atmospheres, and in this oxygen sensor, a semiconductor material whose resistivity changes upon contact with oxygen gas in a state in which a predetermined voltage is applied is used as an oxygen gas detection member.

In this embodiment, a resistive type means that the semiconductor material whose resistivity changes upon contact with oxygen gas is used.

### First Embodiment

### Configuration of Resistive Oxygen Gas Sensor

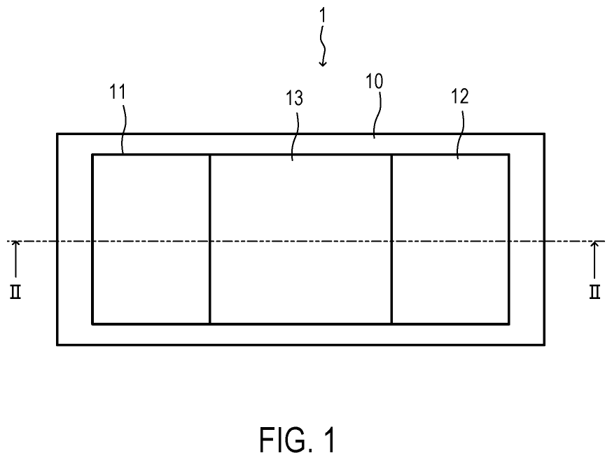

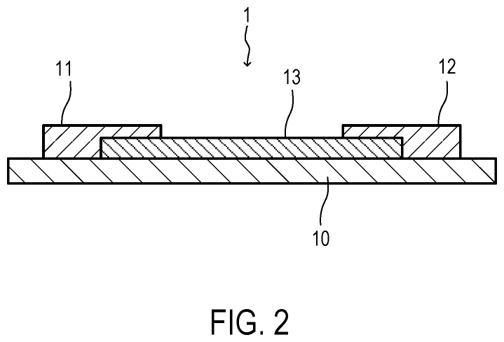

FIG. 1 is a plan view for explaining a resistive oxygen gas sensor 1 according to a first embodiment of the present disclosure. FIG. 2 is a sectional view taken along line II-II shown in FIG. 1.

The resistive oxygen gas sensor 1 is a sensor that has a base material 10, a first electrode 11, a second electrode 12, and an oxygen gas detection member 13, and that is formed by arranging them on the base material 10 having a flat plate shape.

As the base material 10, an insulating material or a semi the insulating material can be used. As the insulating material, a structural ceramic, such as alumina, silicon dioxide, mullite, magnesium oxide, forsterite, or the like, glass, sapphire, or the like can be used. In addition, as the semi the insulating material, silicon carbide, etc. can be used. In addition, any other material normally used as a base material for the gas sensor can be used as the base material 10.

When the base material 10 having the flat plate shape is used, the thickness of the base material 10 may be 0.05 mm or more and 1.0 mm or less. From the viewpoint of strength of the base material 10, it is preferable that the thickness of the base material 10 be equal to or greater than 0.09 mm. In addition, from the viewpoint of thermal conductivity, it is preferable that the thickness of the base material 10 be equal to or less than 1.0 mm.

Normally, the first electrode 11 and the second electrode 12 can be made of the same material used for the electrode or a lead wire. As a conductive material, copper (Cu), aluminum (Al), silver (Ag), gold (Au), platinum (Pt), nickel (Ni), chromium (Cr), tin (Sn), or the like can be used suitably. In addition, a resin electrode made of conductive resin may also be used.

The first electrode 11 and the second electrode 12 can be formed on the surface of the base material 10 by a pattern film formation, etc. using a sputtering method, an ion plating method, a vacuum deposition method, or a laser ablation method, depending on the type of metal used. In addition, the first electrode 11 and the second electrode 12 can be formed on the surface of the base material 10 by printing an electrode material. In addition, other joining methods, such as wire bonding, etc. may also be used.

When the resistive oxygen gas sensor 1 shown in FIG. 1 is formed, the thicknesses of the first electrode 11 and the second electrode 12 may be 0.02 μm or more and 20 μm or less. It is preferable that these thicknesses be equal to or greater than 0.1 μm from the viewpoint of a detection performance for oxygen gas to be detected and be equal to or less than 10 μm from the viewpoint of cost.

Although not illustrated in FIG. 1, the first electrode 11 and the second electrode 12 each has a structure capable of being electrically connected to power supply voltage for applying voltage to the oxygen gas detection member 13.

The oxygen gas detection member 13 is formed on the base material 10 so as to be electrically connected by the first electrode 11 and the second electrode 12.

In this embodiment, the oxygen gas detection member 13 contains, as a main component, the semiconductor material having the composition formula represented by RE(Ba₂₋ₓ, REₓ)Cu₃O_{y} (wherein, RE is a rare earth element, x is 0≤x≤1.2, and y is 6.0≤y≤7.5), in other words, a semiconductor oxide. Details of the semiconductor material forming the oxygen gas detection member 13 will be described below.

In addition, the oxygen gas detection member 13 has a porous structure and is formed as a film having a predetermined thickness. As the oxygen gas detection member 13 has the porous structure, the time required for oxygen ions (O²⁻) to diffuse into a crystal structure is reduced. As a result, it is possible to improve a responsiveness (a sensitivity) of the oxygen gas detection member 13 for oxygen gas.

The oxygen gas detection member 13 may be applied over a predetermined region between the first electrode 11 and the second electrode 12 as shown in FIG. 1, or may be formed so as to connect portions of the first electrode 11 and the second electrode 12. Although not illustrated in FIG. 1, an insulating layer may be formed on the surface of the base material 10, and the first electrode 11 and the second electrode 12 may be arranged on a surface of the insulating layer.

In addition, it is preferable that the resistivity of the oxygen gas detection member 13 be equal to or higher than 0.035 £2 cm. Furthermore, it is even more preferable that the resistivity of the oxygen gas detection member 13 be equal to or lower than 0.21 £2 cm.

When the resistivity is too low, noise components such as contact resistance, etc. will be increased for the resistance value output from the oxygen gas detection member 13. On the other hand, when the resistivity is high, a electric current value applied to the oxygen gas detection member 13 becomes too small, making it difficult to measure the resistance value output from the oxygen gas detection member 13. From the above viewpoint, when the resistivity of the oxygen gas detection member 13 falls within the above-described value range, it is possible to keep the overall size of the resistive oxygen gas sensor 1 within a predetermined size while maintaining the oxygen gas detection capability.

### Semiconductor Material

Next, the details of the oxygen gas detection member 13 will be described. The oxygen gas detection member 13 is formed so as to contain, as the main component, the semiconductor material having the composition formula represented by RE(Ba₂₋ₓ, REₓ)Cu₃O_{y}. In the above-described composition formula, x is 0≤x≤1.2, and y is 6.0≤y≤7.5.

In the above-described composition formula, RE is at least one element selected from the rare earth elements (Sc (scandium), Y (yttrium), La (lanthanum), Nd (neodymium), Sm (samarium), Eu (europium), Gd (gadolinium), Dy (dysprosium), Ho (holmium), Er (erbium), Tm (thulium), Yb (ytterbium), and Lu (lutetium)).

As the rare earth element RE, any one of the above-described elements may be used alone, or a mixture of a plurality of the elements may also be used. It is preferable that the same element be used for REs at two positions in the composition formula because it becomes easier to control the composition of the semiconductor material and to perform management during the production.

In addition, in this embodiment, the semiconductor material has the composition in which a part of the composition formula: RE(Ba₂₋ₓ, REₓ)Cu₃O_{y} is replaced with Group 2 element in the periodic table and the rare earth element.

In the above, the Group 2 element in the periodic table is any one element selected from beryllium (Be), magnesium (Mg), calcium (Ca), strontium (Sr), barium (Ba), and radium (Ra).

In addition, the lanthanoid element is any one element selected from lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

Under the same temperature condition, as the value of x approaches 0, there is a tendency for the resistivity of the semiconductor material forming the oxygen gas detection member 13 to decrease and for the difference in the resistivity of the semiconductor material depending on the temperature to increase.

In addition, generally, a dependency of the electrical conductivity o [S/m] of the resistive oxygen gas sensor at a given temperature on oxygen partial pressure P_{O2} [atmosphere] is known to be represented as follows using a factor m.

$$σ ∝ {P}_{O 2}^{1 / m} \qquad ( 1 )$$

In Equation (1), the value of the factor m varies depending on the type of defects in the semiconductor oxide (the semiconductor material), impurity concentration, measurement temperature, and so forth. According to Equation (1), it means that, at a given temperature, the smaller the absolute value of the factor m (>0) is, the better the responsiveness (the sensitivity) of the oxygen gas sensor becomes.

Therefore, when the temperature of the measurement environment is changed, if the amount of change of the absolute value of the factor m is small, it can be said that the temperature dependency is small. From this, it can be said that the smaller the absolute value of the factor m in Equation (1) is and the smaller the amount of change of the value of the factor m due to the temperature change is, the better the sensitivity and the higher the stability of the resistive oxygen gas sensor become.

The factor m can be calculated as follows using the oxygen partial pressure P₁ in the atmospheric gas surrounding the semiconductor material, the resistance value R₁ of the semiconductor material at the oxygen partial pressure P₁, the oxygen partial pressure P₂, and the resistance value R₂ of the semiconductor material at the oxygen partial pressure P₂.

$$m = \frac{log {P}_{2} - log {P}_{1}}{log {R}_{1} - log {R}_{2}} \qquad ( 2 )$$

As described above, based on a relationship between the value of x and the value of the factor m in the composition formula, it is preferable that the value of x satisfies 0.4≤x≤ 0.8.

When the value of x in the composition formula is less than 0.4, the temperature region at which the amount of change of the value of the factor m can be suppressed to a small amount is shifted towards the high-temperature side. In addition, when the value of x in the composition formula exceeds 0.8, the temperature region at which the amount of change of the value of the factor m can be suppressed to a small amount is narrowed.

From the viewpoint of avoiding the shift of the temperature region at which the amount of change of the value of the factor m can be suppressed to a small amount towards the high-temperature side and the narrowing of the temperature region at which the amount of change of the value of the factor m can be suppressed to a small amount, the more preferable range for the value of x in the composition formula is 0.4≤x≤0.6.

In addition, from the above viewpoint, it is preferable that the semiconductor material be formed such that the value of x in the composition formula satisfies 0.4≤x≤0.8 and the value of the factor m obtained from Equation (2) satisfies 3.8≤m≤6.0.

According to Equations (1) and (2), the smaller the absolute value of the factor m (>0) is at a given temperature, the better the responsiveness (the sensitivity) of the oxygen gas sensor becomes. However, if the value of the factor m is less than 3.8, the temperature region, at which the oxygen gas sensor exhibits effective functionality, appears on the high-temperature side beyond the practical range, thereby reducing the practicality.

In addition, if the value of the factor m exceeds 6.0, the temperature dependency becomes significant, and the temperature region, in which the oxygen gas sensor can be effectively used, is narrowed, and so, the practicality is reduced.

Because the temperature region, in which the amount of change of the value of the factor m becomes small, differs depending on the value of x, the preferable value of the factor m is determined according to the value of x.

In the semiconductor material whose the composition formula described above can be represented by RE(Ba₂₋ₓ, REₓ)Cu₃O_{y}, from the viewpoint of easily adjusting the value of x so as to fall within the above-described range, it is desirable to use La, Nd, or Sm, which has a large solid solubility limit of x, for the rare earth element RE. In addition, a plurality of rare earth elements may be combined. In addition, the rare earth element RE may be the semiconductor material that is obtained by adding RE₂BaCuO₅ to Nd123.

### Effects of First Embodiment

The resistive oxygen gas sensor 1 according to the first embodiment includes the oxygen gas detection member 13 that contains, as the main component, the semiconductor material having the composition formula represented by RE(Ba₂₋ₓ, REₓ)Cu₃O_{y} (wherein, RE is the rare earth element, x is 0≤x≤1.2, and y is 6.0≤y≤7.5).

In the above-described semiconductor material, by appropriately selecting the rare earth element RE and the values of x and y from the above-described range, it is possible to prepare the semiconductor material in which the amount of change of the resistivity due to the temperature change is small in a specific temperature region.

Therefore, according to the resistive oxygen gas sensor 1 including the oxygen gas detection member 13 that contains the above-described semiconductor material as the main component, it is possible to reduce the temperature dependency of the responsiveness compared with a conventional resistive oxygen gas sensor.

In addition, according to the resistive oxygen gas sensor 1, by appropriately selecting the rare earth element RE and the value of x for the semiconductor material forming the oxygen gas detection member 13, it is possible to set the temperature region, in which the amount of change of the resistivity of the semiconductor material becomes small, at a temperature region lower than that of the conventional resistive oxygen gas sensor. Therefore, it is possible to provide the resistive oxygen gas sensor 1 that is capable of exhibiting good responsiveness in the temperature region lower than that of the conventional resistive oxygen gas sensor as the oxygen gas sensor.

In addition, by setting the value of x so as to satisfy 0.4≤x≤0.8 in the above-described composition formula, it is possible to set the temperature region, in which the amount of change of the resistivity due to the temperature change is small, so as to fall 450° C. or more and 800° C. or less, and as a result, the resistive oxygen gas sensor 1 that can exhibit the oxygen gas detection capability in the temperature region lower than that of the conventional resistive oxygen gas sensor is obtained.

In particular, if the value of x is in the vicinity of x=0.6, it is possible to reduce the temperature dependency of the resistance value in the vicinity of 700° C. to 800° C. In addition, as a result, it is also possible to reduce the temperature dependency of the resistivity in the vicinity of 700° C. to 800° C.

In addition, by causing the resistivity of the oxygen gas detection member 13 to be 0.035 Ω2 cm or more and 0.21Ω cm or less, it is possible to keep the overall size of the resistive oxygen gas sensor 1 within a predetermined size while maintaining the oxygen gas detection capability, and so, it is possible to reduce the size of the resistive oxygen gas sensor 1.

In addition, in the resistive oxygen gas sensor 1, the temperature region, in which the effective function as the oxygen gas sensor is exhibited, can be set at the practical range by causing the value of m to satisfy 3.8≤m≤6.0 in the relationship σ˜P_{O2}^{1/m} (σ is proportional to P_{O2}^{1/m}) that expresses that the electrical conductivity o [S/m] of the oxygen gas detection member 13 is proportional to (1/m)th power of the oxygen partial pressure P_{O2} [atmosphere].

### Second Embodiment

### Configuration of Resistive Oxygen Gas Sensor

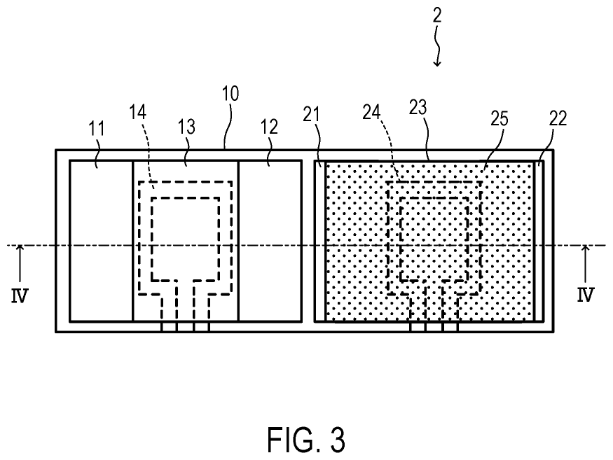

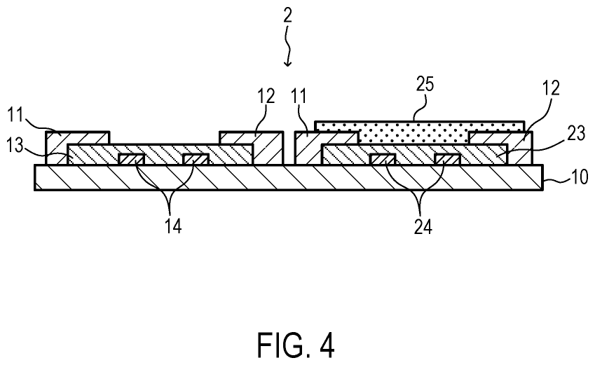

FIG. 3 is a plan view for explaining a resistive oxygen gas sensor 2 according to a second embodiment of the present disclosure. FIG. 4 is a sectional view taken along line IV-IV shown in FIG. 3. The same components as those of the resistive oxygen gas sensor 1 are denoted with the same reference numerals, and a detailed description thereof will be omitted.

The resistive oxygen gas sensor 2 has, similarly to the resistive oxygen gas sensor 1 according to the first embodiment, the base material 10, the first electrode 11, the second electrode 12, and the oxygen gas detection member 13, and in addition, includes a heater electrode 14.

The heater electrode 14 heats the oxygen gas detection member 13. In this embodiment, the heater electrode 14 is formed to have a rectangular loop shape on the surface of the base material 10, and the oxygen gas detection member 13 is stacked on the heater electrode 14 after the heater electrode 14 is formed.

As the heater electrode 14, a heating element of a resistive heating type that utilizes resistive loss may be used. When voltage is applied to both end portions of the heater electrode 14, the heater electrode 14 generates heat due to flow of electric current.

With such a configuration, it is possible to heat the oxygen gas detection member 13 rapidly by the heater electrode 14 until the semiconductor material reaches the temperature region in which good oxygen gas responsiveness is exhibited, and at the same time, it is possible to keep the oxygen gas detection member 13 at the temperature where good responsiveness for oxygen gas is shown.

In addition, the resistive oxygen gas sensor 2 is provided with a temperature compensation unit 23. The temperature compensation unit 23 compensates for the temperature change of the oxygen gas detection member 13. As the material forming the temperature compensation unit 23, it is preferable to use the material that has a temperature dependency similar to that of the oxygen gas detection member 13.

In addition, a material having the resistivity close to the resistivity of the oxygen gas detection member 13 may be used for the temperature compensation unit 23, and a conductive material or the semiconductor material may be used. Furthermore, similarly to the oxygen gas detection member 13, it is preferable that the material be a conductive material whose resistivity changes in accordance with the temperature change.

In this embodiment, the temperature compensation unit 23 is formed of the semiconductor material, which is the main component of the oxygen gas detection member 13, in other words, the semiconductor material having the composition formula represented by RE(Ba₂₋ₓ, REₓ)Cu₃O_{y} (wherein, RE is the rare earth element, x is 0≤x≤1.2, and y is 6.0 ≤y≤7.5).

In addition, the resistive oxygen gas sensor 2 has a heater electrode 24 between the temperature compensation unit 23 and the base material 10 for heating the temperature compensation unit 23 such that the temperature compensation unit 23 becomes equivalent to the temperature of the oxygen gas detection member 13.

The heater electrode 24 is formed of the same material as the heater electrode 14, and in this embodiment, similarly to the heater electrode 14, the heater electrode 24 is formed to have the rectangular loop shape on the surface of the base material 10, and the temperature compensation unit 23 is formed on the heater electrode 24.

In addition, in this embodiment, the resistive oxygen gas sensor 2 has a shielding layer 25, which does not allow passage of oxygen gas, on a surface of the temperature compensation unit 23. The temperature compensation unit 23 is covered by the shielding layer 25, and thereby, the temperature compensation unit 23 is prevented from contact with oxygen gas.

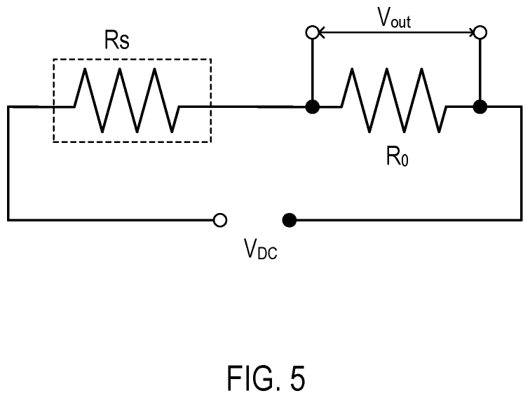

FIG. 5 is a circuit diagram for explaining the resistive oxygen gas sensor according to the second embodiment. The resistive oxygen gas sensor 2 provided with the temperature compensation unit 23 has a circuit configuration shown in FIG. 5.

A resistance Rs shown in FIG. 5 corresponds to the oxygen gas detection member 13. In addition, the reference resistance R₀ corresponds to the temperature compensation unit 23. V_{DC} is the applied voltage to the resistive oxygen gas sensor 2, and Vₒᵤₜ is voltage applied to the reference resistance R₀. In this circuit configuration, a resistance Rs of the oxygen gas detection member 13 can be obtained by following Equation (3).

$${R}_{S} = \frac{{V}_{D C} - {V}_{o u t}}{{V}_{o u t}} {R}_{O} \qquad ( 3 )$$

In Equation (3), when the temperature dependency of the resistance Rs is taken into consideration, if a rate of change of the resistance Rs by temperature is denoted as n, Equation (3) can be expressed as Equation (4) below.

$$n {R}_{s} = \frac{{V}_{D C} - {V}_{o u t}}{{V}_{o u t}} n {R}_{O} \qquad ( 4 )$$

In particular, in a case in which the oxygen gas detection member 13 is formed of the same material as the temperature compensation unit 23 and the shielding layer 25 is provided to shield the temperature compensation unit 23 from oxygen gas, as described in this embodiment, n in Equation (4) is cancelled out. Therefore, with the above-described circuit configuration, it is possible to reduce the resistivity fluctuation in the oxygen gas detection member 13 due to the temperature change.

### Effects of Second Embodiment

With the resistive oxygen gas sensor 2 according to the second embodiment, because the temperature compensation unit 23 that compensates the temperature change of the oxygen gas detection member 13 is provided, compared with the conventional resistive oxygen gas sensor, it is possible to further increase the effect of reducing the temperature dependency of the responsiveness to oxygen gas.

In the resistive oxygen gas sensor 2, the temperature compensation unit 23 is formed of, as the material having the resistivity close to the resistivity of the oxygen gas detection member 13, the semiconductor material, which is the main component of the oxygen gas detection member 13, in other words, the semiconductor material having the composition formula represented by RE(Ba₂₋ₓ, REₓ)Cu₃O_{y} (wherein, RE is the rare earth element, x is 0≤x≤ 1.2, and y is 6.0≤y≤7.5), and the shielding layer 25, which does not allow the passage of oxygen gas, is formed on the surface of the temperature compensation unit 23, and thereby, oxygen gas is not adsorbed to the temperature compensation unit 23.

Therefore, in particular, in a case in which the temperature compensation unit 23 is formed of the same semiconductor material as the oxygen gas detection member 13, only the resistivity change due to the temperature change can be cancelled out.

As a result, it is possible to eliminate noise due to the temperature change in the resistive oxygen gas sensor 2, and thereby, it is possible to increase detection accuracy for oxygen gas.

### [Production Method of Resistive Oxygen Gas Sensor]

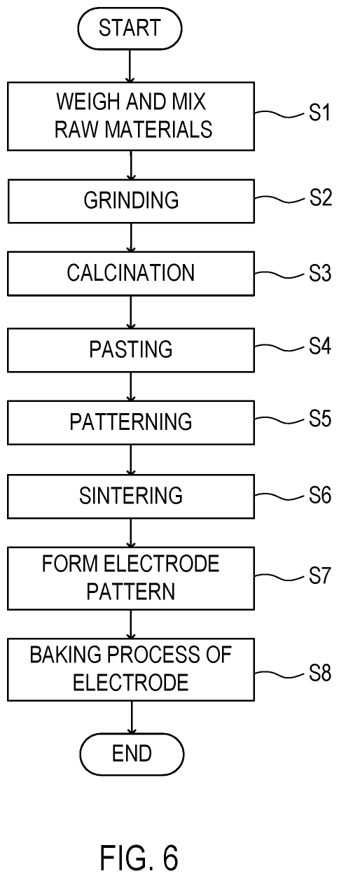

Next, a production method of the resistive oxygen gas sensor 1 will be described. FIG. 6 is a flow chart showing a production method of the oxygen gas detection member 13 according to the first embodiment and the second embodiment.

In Step S1 in FIG. 6, oxides of metal elements forming the composition of the semiconductor material are weighed such that the composition formula after mixing becomes RE(Ba₂₋ₓ, REₓ)Cu₃O_{y}, and these oxides are mixed.

If the rare earth element RE is yttrium, then Y₂O₃ is used, and if the rare earth element RE is lanthanum, then La₂O₃ is used. In addition, BaCO₃ is used for introduction of barium into the composition formula, and CuO is used for introduction of copper. Furthermore, if any of the elements in the composition formula is substituted by calcium as Group 2 element, CaCO₃ is introduced. RE₂BaCuO₅ may further be added to the mixture thus obtained.

In Step S2, each raw material mixed in Step S1 is ground. Methods for grinding include a method using a ball mill device, a solid phase method such as a bead mil using beads as grinding medium, or a liquid phase method. In this embodiment, a ball mill mixing and grinding method, which uses zirconia as the grinding medium and water as solvent, can be used suitably.

In Step S3, the mixture of powders of respective raw materials obtained by mixing and grinding in Step S2 is calcined. As an example of calcination condition, the mixture is subjected to the heating treatment in the atmosphere, at temperature between 880° C. and 970° C. for a predetermined period.

In this embodiment, from the viewpoint of adjusting a reactivity and particle size of the semiconductor material, it is preferable that the heating temperature be between 900° C. and 935° C., and it is further preferable that the heating treatment be performed in the atmosphere, at 900° C., for 5 hours.

Next, in Step S4, pasting process is carried out. In the pasting, a vehicle composed of a binder resin and a solvent is prepared, and the mixture, which has been calcined in Step S3, is added to this vehicle to prepare a paste.

In the pasting, for example, the binder resins such as methyl cellulose, ethyl cellulose, polyvinyl alcohol (PVA), and so forth, and solvents that can dissolve these binder resins may be used. In this embodiment, ethyl cellulose may be used as the binder resin, and terpineol may be used as the solvent.

In Step S5, the paste is formed into a predetermined shape. In this embodiment, a rectangular pattern (the oxygen gas detection member 13 shown in FIG. 1) having a predetermined size is formed on the surface of the base material 10 shown in FIG. 1 by using a screen printing method or a thin film method with the paste obtained by the pasting.

Subsequently, in Step S6, the formed body of the oxygen gas detection member 13 that is formed in Step S5 is sintered. The sintering temperature may be between 900° C. and 1000° C. The optimum value of this sintering temperature may be appropriately selected according to the composition formula of the semiconductor material.

As an example, the sintering is performed in the atmosphere, at 950° C. for 1 hour. After the sintering process, an annealing process may further be performed.

Subsequently, in Step S7, using the electrode material, rectangular electrode patterns (the first electrode 11 and the second electrode 12) are formed on both end portions of the oxygen gas detection member 13 by a film deposition such as the screen printing method, the sputtering, and so forth.

Next, in Step S8, the first electrode 11 and the second electrode 12 formed in Step S7 are heated and baked. Although the baking condition may be appropriately selected according to the electrode material, thickness, and so forth to be used, in order to suppress excessive sintering or reaction progression due to overheating of the oxygen gas detection member 13, it is preferable that the temperature be equal to or lower than 1000° C. In this embodiment, as an example, the baking process is performed under the baking condition of 700° C., 20 minutes in the atmosphere.

According to the above steps, the resistive oxygen gas sensor 1 shown in FIGS. 1 and 2 can be fabricated.

Furthermore, when the resistive oxygen gas sensor 2 shown in FIGS. 3 and 4 is to be fabricated, prior to the formation of the electrode pattern in Step S7, the oxygen gas detection member 13 is arranged on the base material 10 in Step S5 after the heater electrodes 14 and 24 are formed at predetermined positions of the base material 10. In addition, in the same step as this step, it is possible to form the temperature compensation unit 23 at adjacent position to the oxygen gas detection member 13 by using the semiconductor material formed in the same steps as Steps S1 to S4. Subsequently, a first electrode 21 and a second electrode 22 are formed so as to respectively cover connection parts of the electrode. After the baking in Step S8, the shielding layer 25 may be arranged so as to cover the temperature compensation unit 23.

### Oxygen Sensor Device

The resistive oxygen gas sensors 1 and 2, described with reference to FIGS. 1 to 4, are applicable to oxygen sensor devices such as a monitoring device that monitors the oxygen concentration in a specific environment, a management device that monitors the oxygen concentration in a specific environment and adjusts the oxygen concentration, or the like.

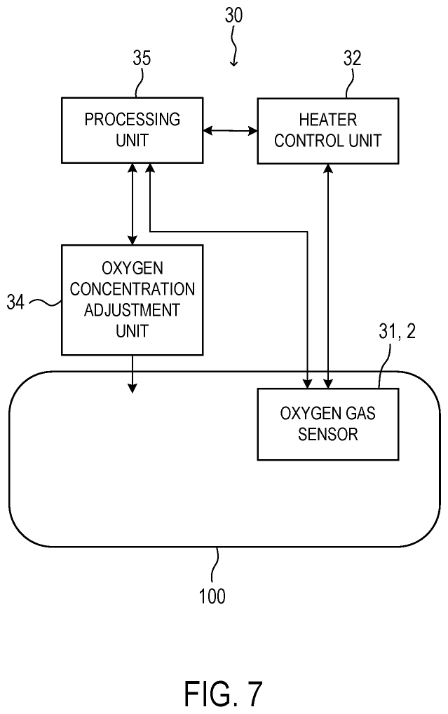

FIG. 7 is a configuration diagram for explaining an oxygen sensor device 30. The oxygen sensor device 30 is provided with an oxygen gas sensor 31 located at a measurement-target environment 100, a heater control unit 32, an oxygen concentration adjustment unit 34, and a processing unit 35, and is a device capable of measuring the oxygen concentration in a specific environment (the measurement-target environment 100) and adjusting the oxygen concentration.

In this embodiment, the oxygen gas sensor 31 corresponds to the resistive oxygen gas sensor 2, described with reference to FIGS. 3 and 4.

The heater control unit 32 performs a control so as to provide a predetermined amount of heat to the heater electrodes 14 and 24 provided in the oxygen gas sensor 31 (the resistive oxygen gas sensor 2), ensuring that the temperature of the oxygen gas sensor 31 reaches an appropriate operating temperature.

The oxygen concentration adjustment unit 34 is connected to an oxygen gas source (not shown) and has a configuration that enables introduction of oxygen gas from the oxygen gas source to the measurement-target environment 100 such that the oxygen concentration in the measurement-target environment 100 becomes a predetermined concentration.

The processing unit 35 converts a sensor output value from the oxygen gas sensor 31 into the oxygen concentration and, if necessary, sends a control signal to the oxygen concentration adjustment unit 34 to adjust the oxygen concentration in the measurement-target environment 100.

By doing so, the oxygen sensor device 30 can detect the oxygen concentration in the measurement-target environment 100 and adjust the oxygen concentration in the measurement-target environment 100.

The oxygen sensor device 30 may also be provided with a display unit such as a liquid crystal panel, etc. that displays the oxygen concentration and information for operation. In addition, the oxygen sensor device 30 may also be provided with an operation unit having various operation switches for inputting information necessary for a setting operation of measurement conditions, management of the oxygen concentration, and so forth. Instead of mechanically configured operation switches, a touch panel provided in the display unit may also be employed.

In this embodiment, the configuration of the oxygen sensor device is not limited thereto. In addition, the oxygen sensor device 30 may be a computer, and the processing unit 35 may be configured of a CPU of the computer. In addition, the processing unit 35 may be configured of a plurality of microcomputers.

### OTHER EMBODIMENTS

Although the embodiments of the present disclosure have been described in the above, the above-mentioned embodiments merely illustrate a part of application examples of the present disclosure, and the technical scope of the present disclosure is not intended to be limited to the specific configurations of the above-described embodiments.

For the method of forming the first electrode 11 and the second electrode 12 on the base material 10, a thick film method, the thin film method, a coating device equipped with a dispenser, or the like may also be applied. The shape of the first electrode 11 and the second electrode 12 is not limited to the rectangular shape. They may be so-called comb-shaped electrodes. In order to increase the resistance value, it is preferable that the first electrode 11 and the second electrode 12 have the rectangular shape.

In this embodiment, the oxygen gas detection member 13 may also have, in addition to the rectangular shape, so-called a meander shape (a snake-like shape), a serpentine shape (a serpent-like shape), or the like. From the viewpoint of achieving both of size reduction and high resistance for the resistive oxygen gas sensors 1 and 2, the meander shape is more preferred.

In this embodiment, for the method of forming the heater electrodes 14 and 24 on the base material 10, the same method as those for the first electrode 11 and the second electrode 12 may be applied. The shapes of the heater electrodes 14 and 24 are not limited to the shape shown in FIGS. 3 and 4. So-called comb-like shape, the meander shape (the snake-like shape), the serpentine shape (the serpent-like shape), or the like may be appropriately set.

The heater electrode 14 only needs to be able to heat and maintain the temperature of the oxygen gas detection member 13 at a predetermined temperature, and in the base material 10, the heater electrode 14 may be formed on the opposite side of the surface on which the oxygen gas detection member 13 is formed.

Instead of using the heater electrode 24, the heater electrode 14 may be wired on the base material 10 so as to be able to heat the oxygen gas detection member 13 and the temperature compensation unit 23 by single heater electrode 14.

In a case in which the oxygen gas detection member 13 and the temperature compensation unit 23 are maintained at substantially the same temperature through heat conduction via the base material 10, the resistive oxygen gas sensor 2 shown in FIGS. 3 and 4 may not be provided with the heater electrode 14 and the heater electrode 24.

In this embodiment, instead of the temperature compensation unit 23, data for compensating the resistivity change for the temperature of the oxygen gas detection member 13 may be input from outside the resistive oxygen gas sensor 2. For example, profile of the resistivity change for the temperature of the oxygen gas detection member 13 may be prepared in a memory, etc., and the resistivity corresponding to the given temperature of the oxygen gas detection member 13 is selected to cancel out by computation. By doing so, it is possible to eliminate noise component due to the temperature change.

In a production method of the resistive oxygen gas sensor according to this embodiment, in addition to the above-described printing method, an isostatic pressing method, a hot pressing method, a doctor blading method, a uniaxial pressing method, and so forth may be employed to apply press pressure to granulated powder, thereby forming a press-formed body. In this case, in the production steps, the press-formed body is subjected to dicing to cut and process it into a predetermined shape and size.

### EXAMPLE

Test specimens based on the resistive oxygen gas sensor 1 according to the embodiment of the present disclosure were prepared, and various measurements were carried out on the test specimens obtained to perform an evaluation as the oxygen gas sensor. In the following, the method of preparing the test specimens and their evaluations will be described.

### Preparation of Test Specimens

### Resistive Oxygen Gas Sensor

In the semiconductor material having the composition formula represented by RE(Ba₂₋ₓ, REₓ)Cu₃O_{y} (wherein, RE is the rare earth element, x is 0≤x≤1.2, and y is 6.0≤y≤ 7.5), neodymium (Nd) was used as the rare earth element. In addition, semiconductor materials A, B, C, and D were prepared by changing respective values of substitution amounts x and y. In addition, by using each of the semiconductor materials, test specimens 1 to 4 of the resistive oxygen gas sensor were prepared with the method shown in FIG. 6.

In the following, in the above-described composition formula, the semiconductor material prepared such that x=0 is denoted as the semiconductor material A, the semiconductor material prepared such that x=0.4 is denoted as the semiconductor material B, the semiconductor material prepared such that x=0.6 is denoted as the semiconductor material C, and the semiconductor material prepared such that x=0.8 is denoted as the semiconductor material D.

In accordance with the production method shown in FIG. 6, oxides of neodymium (Nd), barium (Ba), and copper (Cu), in other words, Nd₂O₃, BaCO₃ and CuO, forming the semiconductor materials A to D were weighed and mixed so as to achieve the value of x and the value of y in the desired test specimen in Nd(Ba₂₋ₓ, Ndₓ)Cu₃O_{y}. Note that the value of y varies in the range of y=6 to 7.5, depending on the oxide added to adjust the value of x.

As the method for mixing and grinding, the ball mill mixing and grinding method using zirconia as the grinding medium and water as the solvent was applied.

Subsequently, the mixture of the powders of the raw materials obtained was subjected to calcination process at 900° C., for 5 hours in the atmosphere. By doing so, the semiconductor materials A to D were obtained.

Subsequently, ethyl cellulose was used as the binder resin, and terpineol was used as the solvent to prepare the vehicle. The mixture after the calcination process (the semiconductor materials A to D) was added to the vehicle and kneaded.

Subsequently, the vehicle containing the mixture was printed on an alumina substrate serving as the base material 10 by the screen printing method, and a rectangular pattern for the oxygen gas detection member 13 shown in FIG. 1 was formed. The size of the alumina base material and the size of the oxygen gas detection member 13 were as follows.

The size of the base material 10: length 6.3 mm×width 3.1 mm× thickness 0.5 mm

The size of the oxygen gas detection member 13: length 5.8 mm× width 0.25 mm× thickness 0.02 mm (the size after printed and dried)

Subsequently, the alumina substrate, and the formed body of the oxygen gas detection member 13 that was formed on the alumina substrate by printing were heated under the condition of 950° C. for 1 hour in the atmosphere, and debinding process was performed.

Subsequently, by using silver (Ag) paste as the electrode material for the first electrode 11 and the second electrode 12, the electrode patterns having the rectangular shape were formed by a printing method on both end portions of the oxygen gas detection member 13 that was formed on the alumina substrate by printing.

Subsequently, after the electrode patterns were formed, the baking process was performed under the baking condition of 700° C. for 20 minutes in the atmosphere.

By the above-described steps, the test specimens 1 to 4 of the resistive oxygen gas sensor were obtained.

### Hot-Spot Oxygen Gas Sensor

Among the semiconductor materials A to D described above, the semiconductor material A (x=0) and the semiconductor material C (x=0.6) were used to prepare test specimens 5 and 6 of a hot-spot oxygen gas sensor.

The hot-spot oxygen gas sensor is the sensor that employs the fact that the semiconductor material that is used as the gas detection member of the oxygen gas sensor exhibits a heated region known as “a hot spot” by the applied voltage. Because the electric current becomes constant in the hot spot regardless of the applied voltage, it is possible to detect adsorption of oxygen gas to the hot spot as a change in the electric current value.

In this embodiment, as in the dicing in Step S6 shown in FIG. 6, a linear body having a square cross-section of 0.3 mm×0.3 mm×7 mm was formed.

Subsequently, the debinding process was performed on the linear bodies made of the semiconductor materials A and C obtained by the dicing by heating them under the condition of 950° C. for 1 hour in the atmosphere.

Subsequently, after the debinding process, silver (Ag) was dip-coated onto end portions of the linear bodies, dried at 150° C. for 10 minutes, and thereby, the connection parts of the electrodes were formed on both end portions of the linear bodies.

Subsequently, silver (Ag) wires each having a diameter of 0.1 mm were attached to the connection parts by the wire bonding, and dried at 150° C. for 10 minutes.

Subsequently, the baking process was performed on the linear bodies made of the semiconductor material, to which the electrodes were respectively attached by the wire bonding as described above, under the baking condition of 670° C. for 20 minutes in the atmosphere, and thereby, the test specimens 5 and 6 of the hot-spot oxygen gas sensor were obtained.

### Evaluation Method

### Measurement of Resistance Value and Resistivity of Semiconductor Material

Each of the above-described test specimens 1 to 4 connected to a multimeter was placed in a temperature-variable chamber, and the resistance value (Ω) detected with each test specimen was measured while changing the temperature in the chamber.

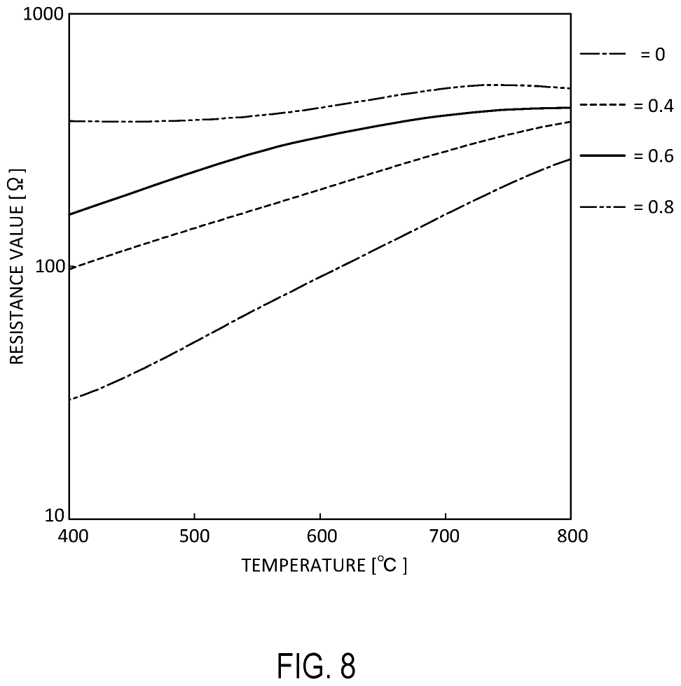

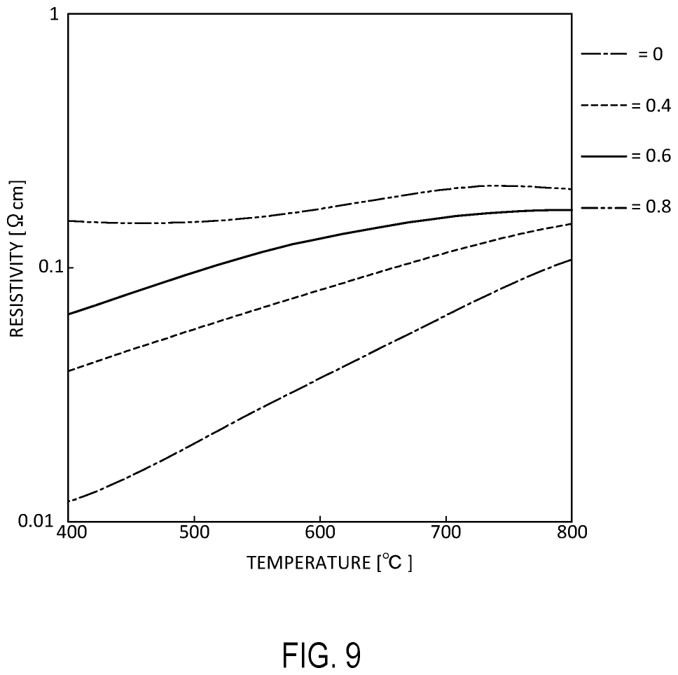

In addition, the resistivity (Ω cm) was calculated based on the shape of the semiconductor material used for each test specimen. Results of the measurements of the resistance value are shown in FIG. 8, and the results for the resistivity are shown in FIG. 9.

### Calculation of Temperature Dependency of Oxygen Gas Responsiveness

For the test specimens 1 to 4, the factor m that represents the oxygen partial pressure dependency in the atmospheric gas was calculated on the basis of Equation (2) described above.

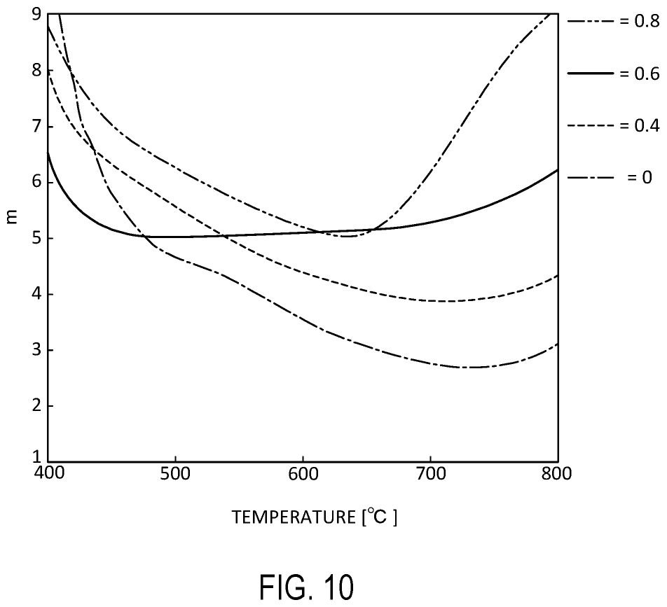

In this example, the temperature of atmosphere surrounding the test specimens 1 to 4 was varied, and the factor m was calculated at each predetermined temperature using the resistance value R₁ (Ω) at the oxygen partial pressure P₁=0.21 (atmospheric pressure) and the resistance value R₂ (Ω) at the oxygen partial pressure P₂=0.01 (atmospheric pressure), and the variation of the factor m due to the temperature change was plotted. The results for the temperature dependency of the factor m are shown in FIG. 10.

### Measurement of Oxygen Gas Responsiveness

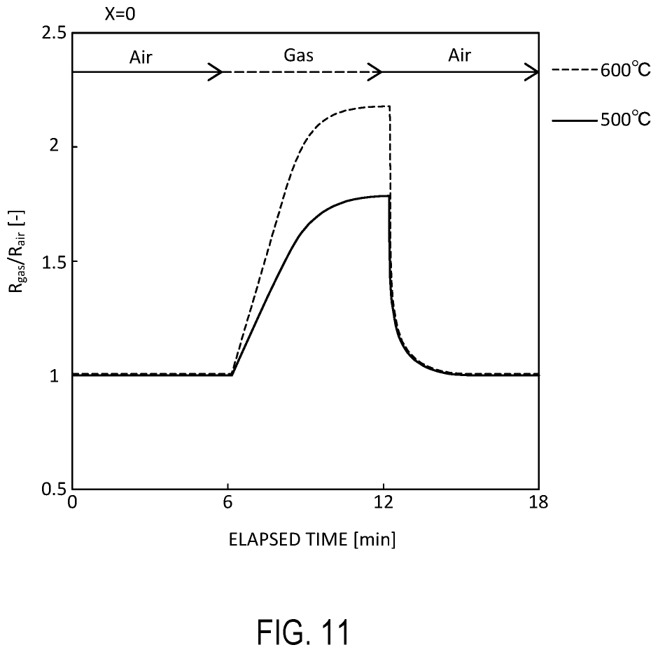

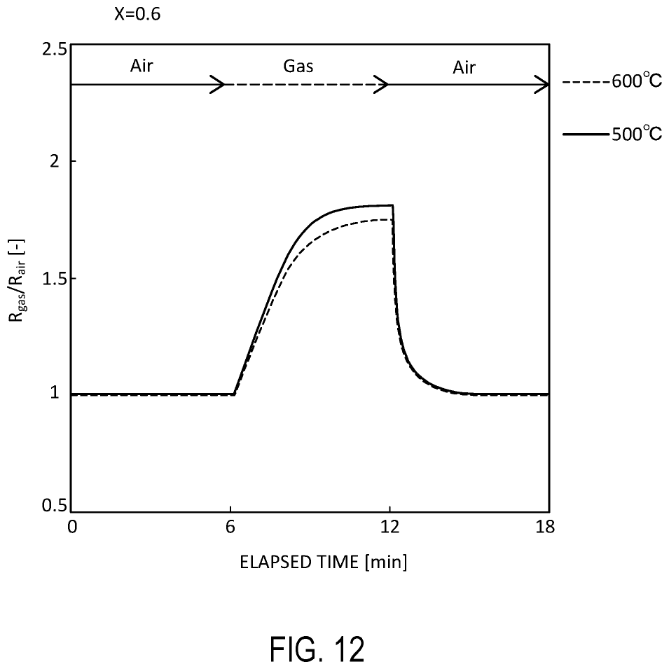

The oxygen gas responsiveness was measured by using the test specimen 1 and the test specimen 3 that were selected on the basis of the calculated results of the temperature dependency of the oxygen gas responsiveness. In this measurement, the atmospheric gas was first set to the atmosphere: Air (P_{O2}=0.21 atmospheric pressure), oxygen gas (P_{O2}=0.01 atmospheric pressure) was fed after 6 minutes, and the atmosphere: Air (P_{O2}=0.21 atmospheric pressure) was fed again after 6 minutes, and during this period, the resistance value change was measured for the test specimens 1 and 3. The results for oxygen gas responsiveness are shown in FIGS. 11 and 12.

### Comparison Between Resistive Oxygen Gas Sensor and Hot-Spot Oxygen Gas Sensor

The sensor sensitivity of the test specimen 1 that was the resistive oxygen gas sensor made by using the semiconductor material A (x=0) was compared with the sensor sensitivity of the test specimen 5 that was the hot-spot oxygen gas sensor made by using the semiconductor material A (x=0). In addition, the sensor sensitivity of the test specimen 3 that was the resistive oxygen gas sensor made by using the semiconductor material C (x=0.6) was compared with the sensor sensitivity of the test specimen 6 that was the hot-spot oxygen gas sensor made by using the semiconductor material C (x=0.6).

For the test specimens 1 and 3 of the resistive oxygen gas sensor, the sensor sensitivity was obtained when the specimens were maintained at 500° C. The results are shown in Table 2.

### Evaluation Results

### Results of Resistance Value and Resistivity of Semiconductor Material

FIG. 8 is a diagram showing a relationship between the temperature change and the resistance value change of the test specimens 1 to 4. In addition, FIG. 9 is a diagram showing a relationship between the temperature change and the resistivity change of the test specimens 1 to 4.

In FIGS. 8 and 9, the measurement results for the test specimen 1 made by using the semiconductor material A (x=0) is represented by a one-dot chain line, the measurement results for the test specimen 2 made by using the semiconductor material B (x=0.4) is represented by a dotted line, the measurement results for the test specimen 3 made by using the semiconductor material C (x=0.6) are represented by a solid line, and the measurement results for the test specimen 4 made by using the semiconductor material A (x=0.8) are represented by a two-dot chain line.

According to FIG. 8, it was found that the temperature dependency of the resistance value for the test specimen 1 made by using the semiconductor material A (x=0) can be reduced along with the increase in the value of x.

This is thought to be due to the fact that in the semiconductor material represented by Nd(Ba₂₋ₓ, Ndₓ)Cu₃O_{y} (wherein, 0≤x≤0.8, and y is 6.0≤y≤7.5), the divalent barium (Ba) sites were substituted by trivalent neodymium (Nd) and hole careers were reduced, and thereby, the semiconductor characteristic cancelled out the original metallic characteristic.

In particular, in the test specimen 3 made by using the semiconductor material C (x=0.6), the temperature dependency of the resistance value in the vicinity of 700° C. to 800° C. is small, and accordingly, the temperature dependency of the resistivity is also small in a similar manner.

From the above, it is expected that the semiconductor material, in which x is about 0.6 in Nd(Ba₂₋ₓ, Ndₓ)Cu₃O_{y}, may be suitably used as the oxygen gas sensor with minimal temperature influence.

In general, NdBa₂Cu₃O_{y} has a low resistivity, and for example, when a film-shaped oxygen gas sensor element as the oxygen gas detection member 13 shown in FIG. 1 is formed, the resistance value becomes several tens of ohms. In addition, when the resistance value is equal to or lower than 100Ω, there is a problem in that the resistance value is easily affected by wiring resistance, and so, it becomes difficult to accurately measure the resistance value of the oxygen gas sensor element itself.

In contrast, for example, by forming the oxygen gas sensor element in the meander pattern, it is possible to increase the resistance value of the oxygen gas sensor element to some extent, thereby facilitating the detection of the resistance value of the oxygen gas sensor element itself.

However, due to the technical limitations of the printing accuracy of the printing method used to form the oxygen gas sensor element to have the film shape, it was difficult to form the oxygen gas sensor element with a film thickness that makes the resistance value of the oxygen gas sensor element ten times or more, for example.

In contrast, as shown in FIG. 8, when the semiconductor materials B, C, and D were used, in other words, when x was set to the range of 0.4 to 0.8 in Nd(Ba₂₋ₓ, Ndₓ)Cu₃O_{y}, it was found that the resistance value can be adjusted in a high range of about 100 $2 to 400 $2.

This indicates that the semiconductor material, with 0.4≤x≤0.8 and 6.0≤y≤7.5 in Nd(Ba₂₋ₓ, Ndₓ)Cu₃O_{y}, is the semiconductor material that can suitably be used for the oxygen gas sensor.

### Results for Temperature Dependency of Oxygen Gas Responsiveness

FIG. 10 is a diagram showing the temperature dependency of the factor m, which represents the oxygen partial pressure dependency.

In FIG. 10, the measurement results for the test specimen 1 made by using the semiconductor material A (x=0) are represented by one-dot chain line, the measurement results for the test specimen 2 made by using the semiconductor material B (x=0.4) are represented by a dotted line, the measurement results for the test specimen 3 made by using the semiconductor material C (x=0.6) are represented by a solid line, and the measurement results for the test specimen 4 made by using the semiconductor material A (x=0.8) are represented by a two-dot chain line.

As shown in FIG. 10, in the test specimen 1 employing the semiconductor material A (x=0), it was found that the factor m was reduced in the vicinity of 600° C. to 800° C., and a good oxygen gas responsiveness was exhibited in this temperature region.

It was found that as x was increased, there was a tendency for the value of the factor m to increase in a low-temperature range (in the vicinity of 400° C.) and a high-temperature range (800° C. or higher).

This is thought to be due to the fact that, in the semiconductor material represented by Nd(Ba₂₋ₓ, Ndₓ)Cu₃O_{y} (wherein, x=0.6, and y is 6.0≤y≤7.5), the substitution amount of trivalent neodymium (Nd) by divalent barium (Ba) is changed to increase/reduce the hole careers, and thereby, adsorption and desorption characteristics of O²⁻ are changed.

The temperature range in which the amount of change in the factor m in FIG. 10 is equal to or less than 0.1 is shown in Table 1 below.

TABLE 1

| Test | | | Temperature | Temperature |
|---|---|---|---|---|
| Specimen | Substituted | | Range | Difference |
| Number | Number | Factor m | (° C.) | (° C.) |
| 1 | X = 0 | 2.62~2.72 | 696~766 | 70 |
| 2 | X = 0.4 | 3.88~3.98 | 668~756 | 88 |
| 3 | X = 0.6 | 5.06~4.96 | 464~642 | 178 |
| 4 | X = 0.8 | 5.05~5.15 | 604~654 | 50 |

According to FIG. 10 and Table 1, it was found that with the test specimen 3 employing the semiconductor material C (x=0.6), the oxygen gas responsiveness as the oxygen gas sensor can be achieved from the low-temperature range around 450° C., and in addition, the temperature range at which the amount of change of the value of the factor m can be suppressed to a small amount can be selected from a wide range.

Therefore, it was found that the semiconductor material, in which x is about 0.6 in Nd(Ba₂₋ₓ, Ndₓ)Cu₃O_{y}, is less susceptible to changes in the oxygen gas responsiveness due to the temperature fluctuation, enabling the realization of highly accurate and stable oxygen gas sensor.

### Results for Oxygen Gas Responsiveness

FIG. 11 is a diagram showing the oxygen gas responsiveness of the test specimen 1. In addition, FIG. 12 is a diagram showing the oxygen gas responsiveness of the test specimen 3. In FIG. 11, a dotted line represents the results of the responsiveness test performed by setting the atmosphere temperature of the test specimen 1 to 600° C., and a solid line represents the results of the responsiveness test performed by setting it to 500° C. In addition, in FIG. 12, a dotted line represents the results of the responsiveness test performed by setting the atmosphere temperature of the test specimen 3 to 600° C., and a solid line represents the results of the responsiveness test performed by setting it to 500° C.

In both of FIGS. 11 and 12, the resistance value of each of the test specimens 1 and 3 when the atmospheric gas was the atmosphere: Air was denoted as Rₐᵢᵣ, and the resistance value of each of the test specimens 1 and 3 when the atmospheric gas was oxygen gas was denoted as R_{gas}. In addition, R_{gas}/Rₐᵢᵣ was used as an indicator of the oxygen gas responsiveness (hereinafter referred to as sensor sensitivity).

As shown in FIGS. 11 and 12, in the test specimen 1 employing the semiconductor material A (x=0) in which the temperature dependency of the factor m was large, as the atmosphere temperature was increased, the sensor sensitivity (R_{gas}/Rₐᵢᵣ) became better.

On the other hand, in the test specimen 3 employing the semiconductor material C (x=0.6) in which the temperature dependency of the factor m was small, it was found that, even when the atmosphere temperature was increased, the improvement of the sensor sensitivity (R_{gas}/Rₐᵢᵣ) was small, however, the variation of the sensor sensitivity (R_{gas}/Rₐᵢᵣ) due to difference in the atmosphere temperature was small, and it was possible to realize the oxygen gas sensor element with small temperature dependency.

Comparison Results between Resistive Oxygen Gas Sensor and Hot-Spot Oxygen Gas Sensor

In the measurement of the sensor sensitivity, for the resistive oxygen gas sensor, the sensor sensitivity (R_{gas}/Rₐᵢᵣ) that was described in the section “Results for Oxygen Gas Responsiveness” described above was used.

In the hot-spot oxygen gas sensor, the sensor sensitivity was calculated from the change in the electric current 1. Therefore, unlike the resistive oxygen gas sensor, for the hot-spot oxygen gas sensor, the resistance value was reduced when oxygen gas was introduced to the atmosphere: Air, and so, expression Iₐᵢᵣ/I_{gas} was used for ease of the comparison.

The results for the sensor sensitivity of the test specimens 1, 3, 5, and 6 are shown in Table 2.

TABLE 2

| Test Specimen | Substututed | | | |
|---|---|---|---|---|
| Number | Number | Type | Sensitivity | Sensitivity |
| 5 | X = 0 | Hot Spot | Iₐᵢᵣ/I_{gas} | 1.5 |
| 1 | X = 0 | Resistive | R_{gas}/Rₐᵢᵣ | 1.7 |
| 6 | X = 0.6 | Hot Spot | Iₐᵢᵣ/I_{gas} | 1.4 |
| 3 | X = 0.6 | Resistive | R_{gas}/Rₐᵢᵣ | 1.8 |

In an electric-current-detection type sensor, as the above-described value of x in the composition formula approaches 0 in the semiconductor material, there is a tendency for the temperature dependency of the semiconductor material to increase, although the sensitivity to oxygen gas is increased.

From Table 2, compared with the hot-spot oxygen gas sensor (the test specimens 5 and 6), in the resistive oxygen gas sensor (the test specimens 1 and 3), it was found that it was possible to adjust the semiconductor material that can stably achieve a high sensitivity in the low temperature region in the vicinity of 500° C.

In addition, from Table 2, compared with the hot-spot oxygen gas sensor (the test specimens 5 and 6), in the resistive oxygen gas sensor (the test specimens 1 and 3), it was found that it was possible to increase the sensor sensitivity.

The present application claims priority to Japanese Patent Application No. 2021-101083, filed in the Japan Patent Office on Jun. 17, 2021. The contents of this application are incorporated herein by reference in their entirety.

### REFERENCE SIGNS LIST

1, 2 resistive oxygen gas sensor
10 base material
11, 21 first electrode
12, 22 second electrode
13 gas detection member
14, 24 heater electrode
25 shielding layer
30 oxygen sensor device
31 oxygen gas sensor
32 heater control unit
34 oxygen concentration adjustment unit
35 processing unit
100 measurement-target environment

1. A resistive oxygen gas sensor made of ceramic and having an oxygen gas detection member for detecting oxygen gas, wherein:
the oxygen gas detection member contains, as a main component, a semiconductor material having
a composition formula represented by RE(Ba₂₋ₓ, REₓ)Cu₃O_{y}
(wherein, RE is a rare earth element, x is 0≤x≤1.2, and y is 6.0≤y≤7.5).

2. The resistive oxygen gas sensor according to claim 1, wherein x satisfies 0.4≤x≤0.8 in the composition formula.

3. The resistive oxygen gas sensor according to claim 1, wherein a resistivity of the oxygen gas detection member is equal to or higher than 0.035 Ω cm.

4. The resistive oxygen gas sensor according to claim 1, wherein
a value of m satisfies 3.8≤ m≤6.0 in a relationship σ˜P_{O2}^{1/m} (σ is proportional to P_{O2}^{1/m}) expressing that an electrical conductivity σ [S/m] of the oxygen gas detection member is proportional to (1/m)th power of an oxygen partial pressure P_{O2}[atmosphere].

5. The resistive oxygen gas sensor according to claim 1, wherein the oxygen gas detection member has a porous structure and is formed to as a film having a predetermined thickness.

6. The resistive oxygen gas sensor according to claim 1, further including:
a heater electrode configured to heat the oxygen gas detection member.

7. The resistive oxygen gas sensor according to claim 1, further including:
a temperature compensation unit configured to compensate a temperature change in the oxygen gas detection member.

8. The resistive oxygen gas sensor according to claim 7, wherein
the temperature compensation unit is a semiconductor material having
the composition formula represented by RE(Ba₂₋ₓ, REₓ)Cu₃O_{y}
(wherein, RE is a rare earth element, x is 0≤x≤1.2, and y is 6.0≤y≤7.5),
the semiconductor material being the main component of the oxygen gas detection member.

9. The resistive oxygen gas sensor according to claim 7, wherein
the temperature compensation unit is shielded from the oxygen gas.

10. The resistive oxygen gas sensor according to claim 1, wherein
the rare earth element is at least one element selected from lanthanum (La), neodymium (Nd), and samarium (Sm).

11. An oxygen sensor device comprising the resistive oxygen gas sensor according to claim 1.
